(19) United States
(12) Patent Application Publication
(10) Pub. No.: US 2026/0121874 A1
(43) Pub. Date: Apr. 30, 2026

(54) Entropy Annealing System and Process for Designing Physical Unclonable Functions

(71) Applicant: Garrett Sawyer, Newbury, MA (US)

(72) Inventor: Garrett Sawyer, Newbury, MA (US)

(21) Appl. No.: 19/370,847

(22) Filed: Oct. 28, 2025

Related U.S. Application Data
(60) Provisional application No. 63/712,850, filed on Oct. 28, 2024.

(51) Int. Cl. H04L 9/32

(52) U.S. Cl. CPC H04L 9/3278

(57) ABSTRACT

A method and system for configuring a physical unclonable function (PUF) using an entropy annealing process. An initial bitstream configuration configures the PUF circuit, such as a ring oscillator, in a field programmable gate array (FPGA) in a low entropy state. Random changes are incrementally made to the FPGA bitstream to progressively move the PUF towards a high entropy state. Each change is evaluated against fitness criteria and only those that maintain or improve system performance are retained. The process iterates until an annealed high entropy PUF circuit is achieved, providing enhanced complexity and security for cryptographic and authentication applications.

### CROSS-REFERENCE TO RELATED APPLICATIONS

This non-provisional application claims the benefit of priority of U.S. provisional patent application No. 63/712,850, filed on Oct. 28, 2024, which is incorporated herein by reference.

### FIELD OF THE DISCLOSURE

This disclosure relates to methods and systems for designing physical unclonable functions (PUFs), and in particular relates to an entropy annealing process that configures a field programmable gate array (FPGA) implementing a PUF into a high entropy state.

### BACKGROUND

Physical unclonable functions (PUFs) are a relatively new type of security technology that first appeared in the early 2000s when they were introduced on silicon integrated circuits. Despite being relatively recent, PUFs have quickly become a key tool in securing modern systems and protecting sensitive data. A PUF such as a ring oscillator is implemented by an electronic circuit that is designed specifically for security purposes and operates independently of the device that it is protecting. Rather than relying on stored information such as passwords or encryption keys, a PUF relies on the real-world physical characteristics and properties of the device on which the PUF circuit is implemented. Some of these device characteristics and properties are inherently unpredictable due to manufacturing variations and environmental factors.

In digital circuits, for example, the time that it takes for a signal to propagate through a logic gate can vary slightly due to differences in transistor size, material properties, or even temperature fluctuations. Parasitic capacitances can differ slightly due to manufacturing imperfections or circuit layout variations. These and many other slight yet random variations that naturally occur create a unique and unclonable “fingerprint” for the device. Because PUFs rely on physical characteristics and parameters that are not stored in memory and are prohibitively difficult to predict yet straightforward to assess, they are highly effective for secure authentication and anti-counterfeiting measures. When a cryptographic key is derived from the unpredictable physical properties of the device, for example, even the manufacturer cannot anticipate or control the response. The PUF exists in the background as a security feature, verifying the identity of the device on which it is deployed when needed but otherwise not interfering with the device's operation.

While the reliance of PUFs on unpredictable, physical variations makes them highly secure and nearly impossible to clone, these same characteristics introduce certain performance vulnerabilities. Environmental factors such as temperature fluctuations and humidity can affect the physical properties of materials and devices that PUFs rely on, potentially altering their behavior. The performance of electronic components may change slightly as they age, which may cause the PUF to generate inconsistent responses over time. Furthermore, the rapid evolution of cybersecurity threats presents an ever changing landscape where previously secure systems may suddenly become vulnerable. In view of these vulnerabilities, there is a need for a design methodology that can create highly complex systems such as PUFs without compromising between security and performance.

The description provided in this background should not be assumed to be prior art merely because it is mentioned in or associated with this background section. This background may include information that describes one or more aspects of the subject technology.

### SUMMARY

The following summary relates to one or more aspects or embodiments disclosed herein. It is not an extensive overview relating to all contemplated aspects or embodiments, and should not be regarded as identifying key or critical elements of all contemplated aspects or embodiments, or as delineating the scope associated with any particular aspect or embodiment. The following summary has the sole purpose of presenting certain concepts relating to one or more aspects or embodiments disclosed herein in a simplified form to precede the detailed description that follows.

According to aspects of this disclosure, a new approach in PUF design is provided that avoids the problems of working with unknown variables and instead removes the constraints that traditional tools use to model circuits. Whereas traditional circuit modeling aims to create low entropy systems with as few possible states or variations as possible, the approach of this disclosure shifts the focus towards high entropy and allowing the circuit to evolve into more complex and less predictable states while still performing its intended function. An entropy annealing process in which the PUF circuit evolves over time is provided by which the complexity and randomness (entropy) of a PUF configuration space is progressively increased while the overall functionality and stability of the PUF is maintained.

According to aspects of this disclosure, a PUF is implemented by a field programmable gate array (FPGA). An FPGA is a versatile, off-the-shelf, programmable logic device comprising a matrix of reconfigurable look up tables (LUTs) and a network of interconnecting spans that can be programmed to perform complex digital logic functions. FPGAs are configurable after manufacturing to implement custom hardware functions. This reconfigurability makes FPGAs particularly useful for PUF applications because they can be dynamically adjusted to a wide range of complex configuration states while still performing a core function, such as ring oscillation, thereby enhancing the inherent randomness and unpredictability of the system.

A systematic approach is provided that begins by generating an initial bitstream that realizes a PUF circuit in a low entropy state on the FPGA. In one example, a bitstream is generated to realize a basic ring oscillator. The system is set to an initial low entropy configuration from which entropy is progressively increased through random but controlled changes to the FPGA configuration used to realize the ring oscillator. While the changes are random, they are made systematically using stepper and rotation functions to ensure that changes are incremental and that comprehensive use of the FPGA's configuration space is made. Changes may involve selecting particular LUTs and their connections for alteration, for example.

Each configuration change is evaluated against fitness criteria, guiding the retention or reversal of changes based on whether they successfully increase entropy while maintaining the overall functionality of the PUF. Successful changes are kept, while unsuccessful ones are reversed, ensuring that the PUF's complexity and security are continuously enhanced. The iterative nature of this process allows for rapid initial changes that gradually slow as the system stabilizes. This controlled rate of change ensures that the system efficiently progresses towards a high entropy state without compromising stability. The process continues iteratively until specific annealing limits are met, resulting in a high entropy annealed circuit with enhanced complexity and security.

Various additional aspects of this disclosure are described below and depicted in the accompanying figures and will be further apparent based thereon.

### BRIEF DESCRIPTION OF THE DRAWINGS

Various features and advantages of this disclosure will be apparent from the following description and accompanying drawings. The drawings are not necessarily to scale; emphasis instead is placed on illustrating the principles of this disclosure. In the drawings, like reference characters may refer to the same parts throughout the different views. The drawings depict only illustrative examples of this disclosure and are not limiting in scope.

FIG. 1 is a circuit diagram of a PUF circuit in the form of a basic ring oscillator, in accordance with aspects of this disclosure.

FIG. 2A is a diagram conceptually illustrating a look up table (LUT) having four inputs and a single output, in accordance with aspects of this disclosure.

FIG. 2B is a diagram conceptually illustrating a truth table implemented by the LUT of FIG. 2A, in accordance with aspects of this disclosure.

FIG. 2C is a diagram conceptually illustrating a logic tile and interconnecting spans of a field programmable gate array (FPGA), in accordance with aspects of this disclosure.

FIG. 3 is a diagram conceptually illustrating an exemplary FPGA configuration space, in accordance with aspects of this disclosure.

FIG. 4 is a graph illustrating an exemplary decay curve for governing the selection process of a rotation function, in accordance with aspects of this disclosure.

FIG. 5 is a flow diagram illustrating a physical entropy annealing process for configuring an FPGA implementing a PUF into a high entropy state, in accordance with aspects of this disclosure.

FIG. 6A is a graph illustrating the globally driven LUT inputs (GLDI) number as a function of fitting steps of the entropy annealing process, in accordance with aspects of this disclosure.

FIG. 6B is a graph illustrating the difference between the updated bitstream and the initial configuration bitstream as a function of the fitting steps of the entropy annealing process, in accordance with aspects of this disclosure.

FIG. 7 is a graph showing the error rate as a function of the fitting steps of the entropy annealing process, in accordance with aspects of this disclosure.

FIG. 8 is a graph showing the PUF frequency as a function of the fitting steps of the entropy annealing process, in accordance with aspects of this disclosure.

FIG. 9A is a conceptual diagram showing a simplified FPGA configuration space that receives a static input signal and outputs a delayed output signal, in accordance with aspects of this disclosure.

FIG. 9B is a graph illustrating the phase delay between the input and output signals of FIG. 9A, in accordance with aspects of this disclosure.

FIG. 10 is a scatter plot showing the fluctuating delays associated with the FPGA configuration space of FIG. 9A as it iterates through an anneal, in accordance with aspects of this disclosure.

FIG. 11 is a flow diagram illustrating a simulating entropy annealing process for configuring an FPGA into a high entropy state, in accordance with aspects of this disclosure.

FIG. 12 is a block diagram of an exemplary computing environment that may implement some or all of the entropy annealing system and process for designing physical unclonable functions, in accordance with aspects of this disclosure.

### DETAILED DESCRIPTION

The embodiments described herein do not limit the invention to the precise form disclosed, nor are they exhaustive. Rather, various embodiments are presented to provide a description for utilization by others skilled in the art. Technology continues to develop, and elements of the disclosed embodiments may be replaced by improved and enhanced items. This disclosure inherently discloses elements incorporating technology available at the time of this disclosure.

The words “exemplary” and “example” as used herein mean “serving as an example, instance, or illustration.” Any embodiment described herein as “exemplary” or as an “example” should not be construed as preferred or advantageous over other embodiments.

A physical unclonable function (PUF) is a security mechanism, typically implemented as a specialized circuit, that conventionally relies on real-world physical characteristics and properties of the device on which the PUF circuit is implemented to produce a unique, device-specific response to a given input, known as a challenge. This disclosure provides a new approach to PUF design that does not rely on unpredictable and changing physical characteristics of the device on which the PUF circuit is implemented. According to this disclosure, an entropy annealing process in which the PUF circuit evolves over time is provided by which the complexity and randomness (entropy) of a PUF configuration space is progressively increased while the overall functionality and stability of the PUF is maintained.

PUF circuits are often implemented as ring oscillators due to their simple design yet high sensitivity to manufacturing variations. The oscillation frequency of a ring oscillator is highly sensitive to factors such as gate delays, voltage thresholds, wiring capacitances, and other tiny variations that differ from chip to chip due to inherent manufacturing imperfections. While this disclosure is explained primarily in the context of a ring oscillator-based PUF, it should be understood that this disclosure is also applicable to other PUF circuit implementations.

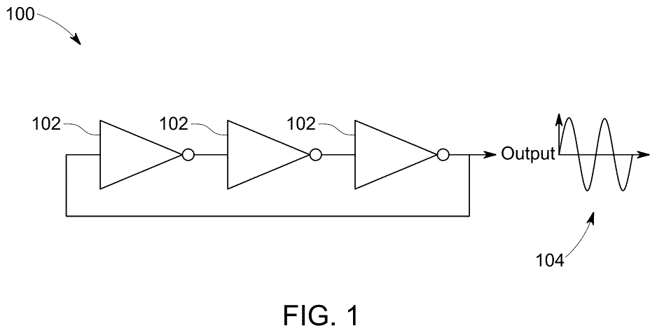

FIG. 1 is a circuit diagram of a PUF circuit in the form of a basic ring oscillator 100. Ring oscillator 100 generates an oscillating feedback signal 104 through a series of inverting logic gates or buffers 102. Inverting buffers 102 are configured in a loop in which the output of the last inverting buffer 102 is fed back into the first inverting buffer 102. When there are an odd number of inverting buffers 102, as shown in FIG. 1, the output and feedback signal 104 naturally oscillate. When implemented as a ring oscillator, as shown in FIG. 1, the uniqueness of a conventional PUF comes from small, inherent material and manufacturing variations and imperfections as described above. These variations affect the oscillation frequency of the circuit such that it is impossible to predict or replicate, and provides a secure method for generating unclonable, device-specific responses.

According to this disclosure, a PUF circuit implementing the function of ring oscillator 100 is provided that has a high degree of entropy and unpredictability without reliance on unknown and possibly changing manufacturing and material variations of the device on which the PUF circuit is implemented. In particular, the PUF of this disclosure is configured in the programmable and reconfigurable space of a field programmable gate array (FPGA), which is a programmable logic device that is custom configurable after manufacturing. FPGAs are well suited for PUF design due to their high complexity and ability to be reconfigured on demand merely by changing information stored in an on-device memory called a bitstream. The bitstream controls the FPGA's behavior and how signals are routed through the FPGA, and also offers a direct way to interact with real, physical semiconductor systems.

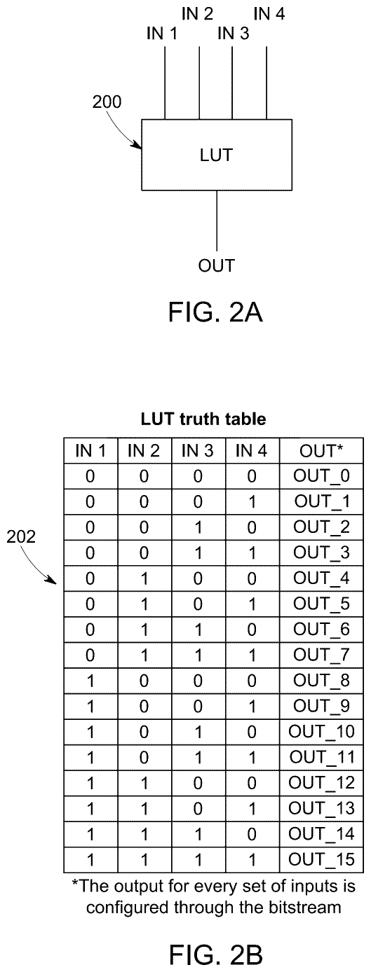

An FPGA is composed of a matrix of configurable logic blocks (CLBs) that are further divided into smaller units called look up tables (LUTs). LUTs are the fundamental building blocks and main computational elements of FPGAs. Each LUT is essentially a programmable memory array that generates a specific output based on a combination of its inputs. That is, the LUT stores the truth table of a logic function. FIG. 2A illustrates a LUT 200 having four inputs IN1, IN2, IN3, IN4 and a single output OUT. This is merely one example; LUT 200 may have other numbers of inputs and outputs. FIG. 2B is a truth table 202 implemented by LUT 200, with four binary inputs (IN1, IN2, IN3, IN4) determining the resulting output (OUT). Given a set of input bits, LUT 200 uses these input bits as an address to look up the corresponding output value. As shown in FIG. 2B, every possible combination of inputs (IN1, IN2, IN3, IN4) leads to a unique output (OUT_0 to OUT_15). The logic within LUT 200 ensures the correct mapping between these inputs and outputs.

LUTs are grouped into larger structures known as logic tiles. FIG. 2C shows an exemplary logic tile 204. Each logic tile 204 contains one or more LUTs, and these tiles serve as the basic units of reconfigurable logic within the FPGA. Tiles 204 not only house the LUTS but also manage the routing of signals between LUTS and other components. Tiles 204 are arranged in a grid-like structure on the FPGA chip and are connected by horizontal or vertical connections 206 known as spans. Spans 206 enable the interconnection of multiple tiles 204 to implement complex digital circuits. Together, LUTs 200 organized into tiles 204 and interconnected by spans 206 allow FPGAs to be programmed to perform a wide variety of tasks.

According to this disclosure, an initial configuration bitstream file is generated to configure the FPGA to realize a basic ring oscillator PUF in a controlled, low-entropy state (a simple, highly organized configuration). The FPGA bitstream is a binary file that comprises, without limitation, instructions for configuring LUTs 200 and tiles 204 and programming them to perform specific functions, instructions for how the interconnects or spans 206 route signals between LUTS 200 and tiles 204, and instructions for how the FPGA's I/O pins are configured. FPGA designers typically use hardware description languages like Verilog or VHDL to define the logic and functionality that the FPGA is to perform (such as a ring oscillator, for example). This design description is then compiled into a bitstream using FPGA design software such as Xilinx Vivado or Intel Quartus. During compilation, the design software performs logic synthesis (translating the high level design into actual hardware logic), place and route (determining how the logic blocks and connections will be laid out physically on the FPGA), and bitstream generation (producing the final binary file that configures the FPGA). The bitstream is then loaded onto the FPGA through a configuration interface and once loaded, the FPGA's internal circuitry is reconfigured to perform the functions specified in the bitstream. Importantly, as will be described below, the FPGA bitstream can be accessed and modified at any time, allowing for dynamic reconfiguration of the FPGA.

By working directly with the FPGA bitstream, more advanced dynamics and interactions can be unlocked within the circuit. However, without structural limits or guardrails, the design could become chaotic or unstable, making it difficult for the circuit to function as intended. Accordingly, annealing limits are set. Setting annealing limits involves determining which area of the FPGA will be reconfigured during the annealing process by selecting a specific part (area of tiles) of the FPGA, allowing for controlled and focused evolution of the circuit. Limits are also set on which spans or connections between the tiles are available, such that the direction in which signals propagate through the circuit is predictable and not chaotic and uncontrolled.

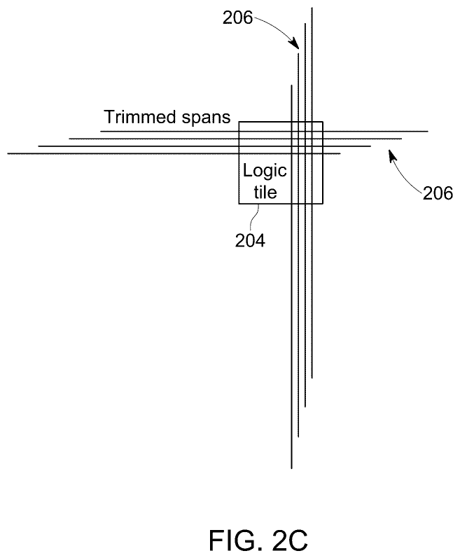

FIG. 3 illustrates an exemplary FPGA configuration space 300 that has been selected and configured as a basic ring oscillator in a low entropy state. Configuration space 300 comprises a plurality of logic tiles 302 that are interconnected by spans and configured to function as a ring oscillator. In particular, logic tiles 302 are interconnected to form a loop, enabling the oscillating behavior characteristic of a ring oscillator. Tiles 304 and 306 are I/O tiles that handle the input and output signals to and from tiles 302. In particular, inputs 308 are fed into FPGA configuration space 300, and outputs 310 are feedback drivers that take the outputs of space 300 and feed them back to inputs 308 to create continuous oscillation.

In its initial configuration as shown in FIG. 3, FPGA configuration space 300 is set to a low entropy, highly ordered state in which all logic tiles 302 are initially driven by global signals, which are special signals that are routed across the entire FPGA and are designed to provide uniform and wide distribution and low skew. Global signals use specialized routing channels that are optimized for long distance transmission. Examples of global signals include clock signals, reset signals, and system control signals. In particular, a global signal feedback control scheme is implemented in which every input of every LUT in tiles 302 of configuration space 300 is configured to be driven by the global signals, and the global signals themselves are then driven by inverted outputs 310 to create the oscillating feedback signal necessary for operation of the ring oscillator. By using globally available signals to artificially restrict the number of configuration states that the FPGA can take, a low entropy state is set that enables an unconstrained optimization process.

This initial configuration, as illustrated in FIG. 3, is critical because it establishes the macrostate functionality required for the PUF to operate effectively. This setup places the FPGA into a highly ordered, low entropy state, where all logic elements are controlled in a precise, predictable manner. Given the vast number of possible configurations that an FPGA can take, this particular arrangement is extremely unlikely to occur by chance, making it a carefully chosen starting point. This configuration is analogous to winding up a spring-it is full of potential energy, and as the system evolves, this tension (potential energy) is gradually released. With each subsequent change, the system moves naturally towards increasing its entropy, introducing more complexity and randomness while still building on the foundation of the initial setup.

From this initial low-entropy state, the annealing process is initiated by introducing random changes into the FPGA bitstream in a controlled manner. These changes increase the system's entropy, or unpredictability, by modifying the configuration of the LUTs and how signals are routed between them, while simultaneously ensuring that the system continues to function correctly (as a ring oscillator). The system gradually evolves from the initial low entropy state, where the majority of LUT inputs are controlled by global signals, toward a more complex configuration. Progressive and random changes reduce the availability of global signals and increase the number of possible microstates, raising the entropy of the system and causing the PUF to grow more complex. This evolution or shift can be measured by tracking the ratio of LUT inputs that are still driven by global signals, which is referred to as the globally driven LUT inputs (GLDI) number. As randomization increases, fewer LUT inputs remain globally driven, and so the GLDI number decreases. This decreasing GLDI number serves as a measurable indicator of the system's progression from a structured, low entropy state to a high entropy, complex configuration. Monitoring this change ensures that the system maintains its correct functionality while simultaneously enhancing its complexity and unpredictability, which are critical for creating a secure and unique PUF.

In some instances, it may be necessary to isolate the PUF and its associated logic from other parts of the FPGA. This can be done by making modifications to the bitstream that separate or “quarantine” the PUF's logic and spans from the rest of the FPGA. This ensures that the random and unpredictable behavior of the PUF does not interfere with other more deterministic functions of the FPGA. It may also be necessary to control how input signals are distributed or “fanned out” to multiple parts of the FPGA. For example, certain input signals might need to be sent to both the PUF and other sections of the chip, or restricted to the PUF only. In some examples, LUTs 200 are programmed to ensure that each LUT 200 only produces an output when all four inputs (IN1, IN2, IN3, IN4) to a given LUT receive a signal. This ensures that signals propagate through the FPGA in a uniform and stable manner while branching and developing more complex pathways. Instead of allowing individual inputs to produce sporadic outputs from LUTs, this programming ensures that only LUTs receiving fully developed sets of synchronized signals are able to generate outputs.

The random changes to the FPGA bitstream to transition from a simple, low entropy configuration to a complex, high entropy configuration must be made in a controlled and manageable fashion, as sudden or large-scale changes to the FPGA bitstream could destabilize the system. A stepper function, which is implemented in the FPGA design software, addresses this by making small and incremental adjustments to elements like the LUT programming (how logic functions are performed), the routing paths, and the spans or interconnects between LUTs. Thus, the stepper function introduces controlled randomness into the bitstream-while the changes are made incrementally, randomness is also introduced into how the LUTs are configured or how signals are routed.

However, simply making random changes to a system with so many parameters is not sufficient to achieve a desired outcome. Without careful control, some reconfigurable elements (e.g., LUTs and spans) might never be selected for modification, and relying on a constant rate of change would make the annealing process prohibitively sow. To address this, a rotation function is implemented to ensure that every element within FPGA configuration space 300 has the opportunity to be modified over time. For example, the rotation function may use a sequence of values to determine which LUT 200 in each tile 204 is selected for modification, and another sequence of values to identify which input of the selected LUT will undergo a span change. The rotation function guarantees that every input of every LUT is selected for potential modification at some point during the annealing process and that all parts of configuration space 300 have an opportunity to evolve. However, as will be described below with respect to the fitness function, whether potential modifications are ultimately made depends on the system's performance and functionality in response to the proposed changes. Only changes that maintain or improve system performance are kept, while those that cause instability or degrade functionality are discarded.

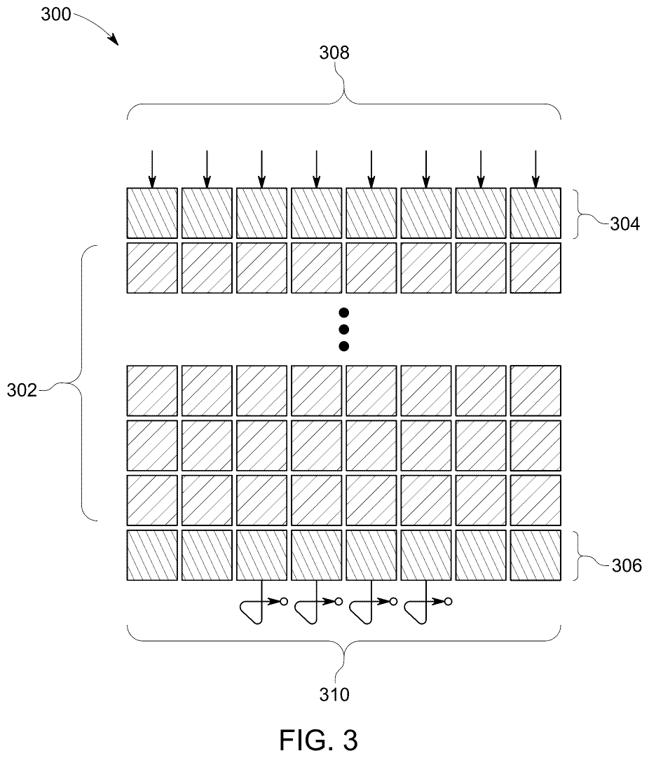

In some examples, the selection process of the rotation function is governed by a decay curve that is a function of the globally driven LUT inputs (GLDI) number for each tile. An exemplary decay curve 400 for governing the selection process of the rotation function is illustrated in FIG. 4. In the early stages of the annealing process, when the circuit is still relatively unoptimized and noisy, the GLDI number is higher and the system undergoes more frequent changes, periodically stressing and relaxing so that changes are maximized early on while the system is more flexible. As can be seen in FIG. 4, for example, when the GDLI number per tile is at its highest (32, in this example), the system is very stressed with 6 changes being selected per tile. The system then relaxes with fewer changes per tile being selected as the GLDI number decreases to 27, at which point the system is again stressed as the changes per tile selected jumps back up to 5, and then begins to relax again. This periodic pattern of stressing and relaxing the configuration ensures that the system evolves efficiently, allowing the circuit to stabilize after significant changes have been introduced. By using a decay curve such as decay curve 400 of FIG. 4 to guide the rotation selection process, in combination with output-oriented propagation delay in which all four inputs are required to generate an output which can slow down the rate of change in regions experiencing significant change or volatility, areas of configuration space 300 that are undergoing a large amount of change can be minimized and allowed to stabilize before further changes are introduced.

As mentioned earlier, only changes that maintain or improve system performance are kept, while those that cause instability or degrade functionality are discarded. The process of determining which changes to the bitstream are kept and which changes are rejected is governed by a fitness function, which plays a critical role in maintaining the stability of a PUF system with so many unknowns. Fitness criteria are set based on the requirements of the specific application. In the case of a ring oscillator-based PUF, for example, the ability of the circuit to continue oscillating is essential for it to maintain its macrostate functionality. Evaluating whether the PUF is oscillating correctly can be done using edge detection, a straightforward method for assessing whether the ring oscillator's functionality remains intact after each modification.

The fitness of the system is calculated against a moving average, meaning that the PUF's performance must equal or exceed its immediate past score for any given step to be considered a successful modification. Every change made during the annealing process is recorded, and if a modification reduces the PUF's fitness, that step is reversed and the previous configuration is re-evaluated. This re-evaluation process is key to ensuring long-term stability, as it prevents temporary or unstable configurations from being locked in. By continuously assessing each step against past performance, the system is able to smoothly transition through local configurations and make new configurations with ease.

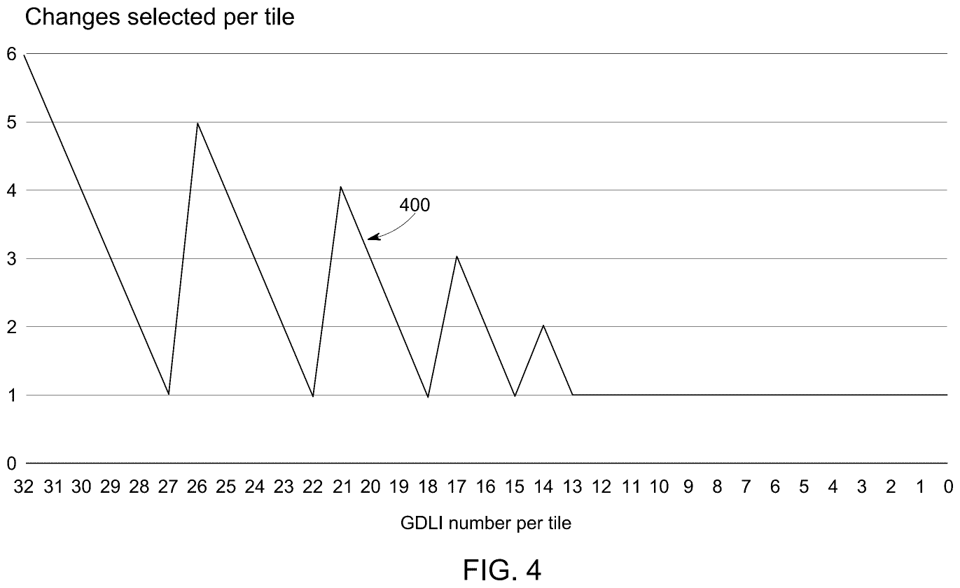

FIG. 5 is a flow diagram illustrating an entropy annealing process 500 for configuring an FPGA implementing a PUF into a high entropy state. Entropy annealing process 500 gradually evolves the FPGA from a low entropy state to a high entropy state through random yet controlled changes to its bitstream. In steps 502 and 504, initial parameters are set that will govern how entropy annealing process 500 is carried out. Annealing limits are set in step 502 by selecting a specific part (area of tiles) of the FPGA for annealing and setting limits on which spans or connections between the tiles are available. Fitness criteria are set in step 504. The fitness criteria are defined based on the specific requirements of the application. For example, in the case of a ring oscillator-based PUF, the ability to oscillate is required to maintain macrostate functionality. The fitness criteria are set to enable evaluation of whether a bitstream change improves, maintains, or does not improve the PUF circuit's performance.

In step 506, an initial configuration bitstream file is generated to configure the FPGA to realize a PUF (such as a ring oscillator) in a controlled, low-entropy state. In the initial, low entropy state, every input of every LUT is configured to be driven by the global signals of the FPGA. From this initial low entropy state, step 508 initiates the annealing process by introducing a random change into the FPGA bitstream. In some examples, the bitstream is updated or changed using stepper and rotation functions. The stepper function makes a small and incremental adjustment to the bitstream such as, for example, changing a span to which an input or output of a LUT is connected or changing the programming of a LUT (the logic function performed by the LUT). The rotation function ensures that all elements of the FPGA-every input of every LUT—are eventually selected for change. The rotation function may be governed, for example, by a delay curve such as decay curve 400 of FIG. 4.

After the FPGA bitstream is updated in step 508, a fitness evaluation is conducted in step 510. Only changes that maintain or improve system performance are kept, while those that cause instability or degrade functionality are discarded. The fitness of the system is calculated against a moving average, meaning that the PUF's performance must equal or exceed its immediate past score for any given step to be considered a successful modification and kept. If the fitness evaluation shows that the fitness of the changed configuration is less than the weighted average fitness of the system (current configuration<weighted average), the system reverses the last change in step 512 and reverts back (“steps backward”) to the previous configuration. This ensures stability and prevents temporary or unstable configurations from being locked in. By contrast, if the fitness evaluation is successful (current configuration≥weighted average), and the annealing limit has not yet been met (step 514—limit not met), then the system “steps forward” and maintains the last change, bringing the system closer to a more complex, high entropy state. Once the annealing limit is met (step 514—limit met), the circuit has undergone sufficient changes and the result is a high entropy annealed circuit.

At its core, entropy annealing is driven by a fitness function that evaluates the evolving configuration states of the FPGA. By constraining changes to occur only when they meet certain fitness criteria, the system approximates the desired behavior within the FPGA's configuration space. In the specific case of a ring oscillator-based PUF, “fitness” may be defined by the positive result of an edge detection function, which identifies transitions in the signal such as rising or falling edges. A positive result is indicated by the successful detection of such transitions, ensuring that the circuit maintains an oscillating signal while simultaneously increasing the complexity of the feedback loop. This increase in complexity contributes to the unpredictability of the PUF, making it more secure and unclonable.

However, the fitness function need not be limited to selecting for unclonability or oscillating signals. The fitness function can be adapted to select for any specific behavior, depending on the desired outcome. For example, instead of using a trigger-based function that relies on signal transitions, the system can optimize configurations to achieve particular, predefined digital states. That is, the system is directed toward a fixed, desired output, with the highest fitness assigned to configurations that achieve this target state. Such an approach allows the FPGA to be programmed so that the outputs reflect these static, predetermined states, which are effectively embedded in the physical configuration of the device. While this may not produce an unclonable circuit, it still permits the development of complex systems in an unconstrained manner.

Furthermore, this flexibility enables the FPGA to be trained to associate specific inputs with corresponding outputs. The system can evolve configurations that either produce fixed outputs for certain inputs or result in variable, statistically defined outputs based on the inputs received. This adaptability allows for a range of dynamic behaviors that go beyond traditional PUF designs, expanding the scope of the entropy annealing process disclosed herein to applications requiring programmable systems that can respond in customized or adaptive ways.

An experiment was designed and run on a demonstration platform to verify that large and complex PUF circuits can be successfully designed using the unconstrained entropy annealing process 500. For the FPGA, a Lattice Semiconductor iCE40 chip was selected for its low cost and the availability of open source software that supports bitstream-level programming. Specifically, electronic design automation (EDA) tools by Yosys were utilized, which allows full access to the bitstream of the iCE40 chip. However, it is important to note that any FPGA with sufficient global signal routing and adequate information regarding its bitstream could be used for the annealing process. For this test, a modified iCE40 8K evaluation board was chosen as the annealing target and interfaced with a DE0 Nano development board manufactured by Terasic Technologies to realize a JTAG (Joint Test Action Group) function, which is commonly used to upload configuration data (such as bitstreams) to programmable devices like FPGAs, as the primary method for sending and receiving data from a computer running the annealing scripts. The scripts facilitate the controlled updates to the bitstream (FIG. 5—step 508), managing the entire annealing process. Additionally, a custom-designed high impedance output buffer board was developed specifically for this experiment. This buffer board provides precise control over the feedback of global signals on the Lattice chip and allows for manual operation when necessary. This setup ensured that the global signals could be manipulated both automatically and manually, which was essential for the controlled progression of the annealing process and the accurate evaluation of results.

The experiment was conducted with a simplified setup, where the global signals where manually switched from high to low for a few cycles, rather than allowing the system to oscillate with feedback directly. This manual control provided greater clarity in assessing the system's response during the annealing process. The fitness criteria were defined such that the system scored highest when the behavior of the global signal drivers, which serve as the feedback mechanism, matched the manually controlled global signals. This is an indicator that the macrostate functionality of the PUF (its essential oscillating behavior) was preserved, even as the PUF circuit's complexity increased and the delay paths lengthened.

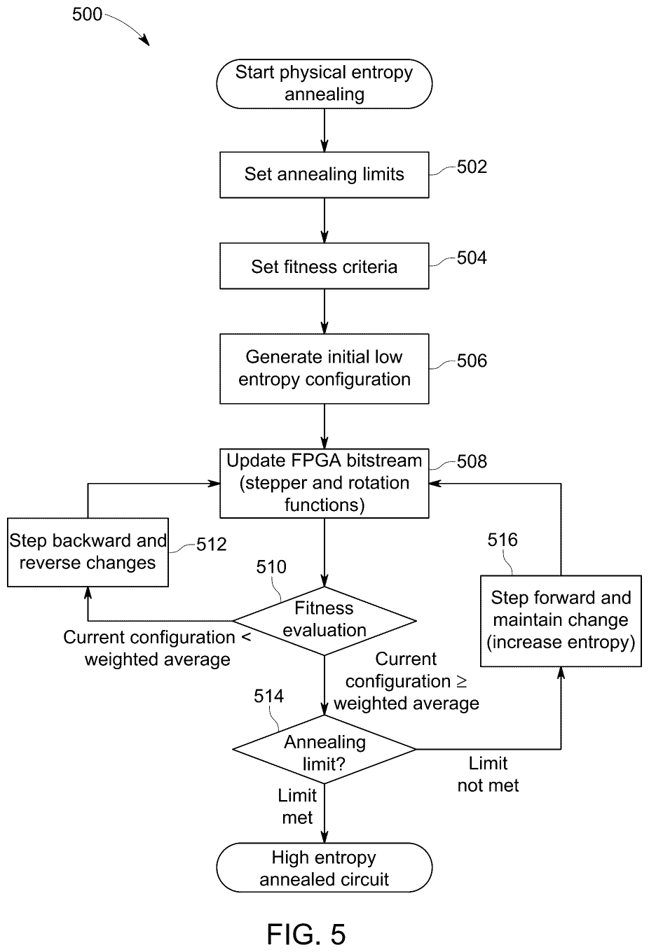

As shown in graph 600 of FIG. 6A, the globally driven LUT inputs (GDLI) number was tracked throughout the annealing process. In graph 600, the “fitting step” numbers along the x-axis refer to each iteration in the annealing process where the configuration of the FPGA is evaluated and updated. Each fitting step corresponds to a discrete modification applied to the FPGA's configuration through the bitstream, followed by an evaluation of the system fitness. As can be seen in FIG. 6A, there was initially a sharp decline in the GDLI number, indicating a high rate of change during the early stages of the annealing process when the system is adjusting and increasing its entropy. As the system evolves and approaches its highest possible entropy, the rate of change decreases and the GLDI number tapers off, reflecting fewer globally driven inputs and a more complex configuration.

In graph 610 of FIG. 6B, the bitstream difference is plotted, comparing the updated bitstream after each iteration on a bit-by-bit basis to the initial configuration bitstream as an absolute value for how different the bitstream is getting. Graph 610 demonstrates the consistent progression away from the original state, with the bitstream becoming increasingly different with each fitting step. The upward trend in the bitstream difference demonstrates how the system is continually evolving and grows more complex as the annealing process advances. These results confirm that the annealing process effectively increases entropy while preserving the functional integrity of the PUF.

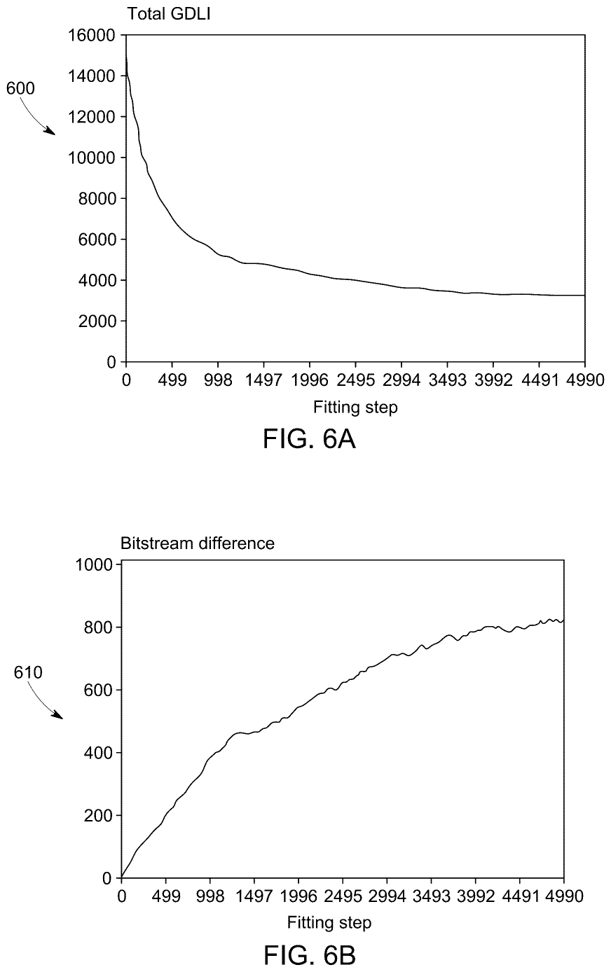

Graph 700 of FIG. 7 depicts the error rate during annealing. The fitness of the system during the annealing process can be measured in terms of an error rate, where a score of 1.00 represents a perfect state (no errors), meaning that the system is functioning ideally. By default, the system starts with an error rate of 1.00, which ensures that the system is initially in a stable and optimal configuration. This starting point makes it relatively easy to make beneficial changes during the early stages of the annealing process, as the primary goal in the beginning is simply to maintain functionality. As long as the system continues to function without major errors, it is able to progress and increase its complexity. The use of a large weighted average in evaluating the fitness is a key factor in maintaining the system's stability, which is why FIG. 7 shows relatively small fluctuations in error rate over time.

The relationship between the error rate and the GDLI metric reveals a key insight into the behavior of the system as it evolves. During periods where the GDLI number is decreasing rapidly—indicating that many changes are being made and the system's complexity is increasing—the system tends to be less stable and scores lower on average in terms of error rate. The introduction of significant modifications in the early stages when complexity grows quickly makes it more challenging to maintain a low error rate. However, as the rate of change slows and the system moves towards a more stable, high entropy state, the system is able to optimize more effectively. This results in greater overall stability, reflected in the more stable error rate seen later in the process (FIG. 7). The error rate begins to improve as the GDLI number approaches the asymptotic limit of maximum entropy, with fewer changes being introduced and the system better able to fine tune its performance. This stabilization of the error rate near the end of the annealing process demonstrates the system's ability to evolve efficiently while maintaining or improving its fitness.x

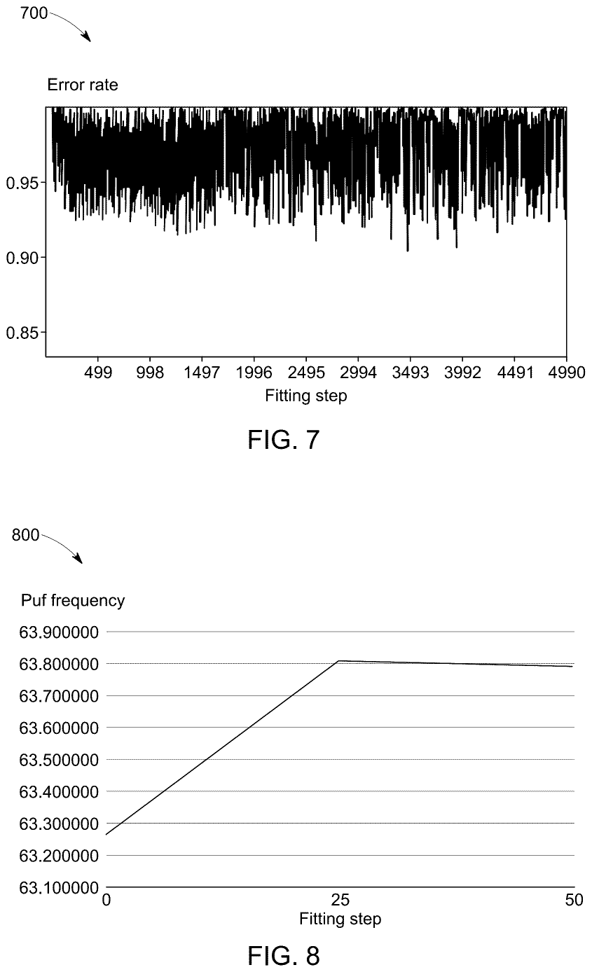

The platform used in this experiment successfully developed oscillating circuits, specifically focusing on the creation of a ring oscillator as the core of the PUF. However, manual verification of the circuit functionality limited the number of iterations that could be feasibly tested during the annealing process. Despite this limitation, the annealing process produced measurable and significant results. As shown in graph 800 of FIG. 8, the PUF frequency changed substantially over the course of just 25 iterations. In particular, the initial frequency of the ring oscillator shifted by over 500 kHz, demonstrating the system's ability to introduce meaningful modifications to the delay paths. This shift in frequency highlights the platform's potential for extremely fine-grained control over the operating frequency of the PUF, allowing for more precise tuning of the circuit as it evolves. The ability to adjust the frequency of the PUF in such a controlled manner offers increased security in applications that require unique, unclonable signatures. This result illustrates the effectiveness of the annealing process in enhancing the complexity of the PUF while maintaining its core functionality.

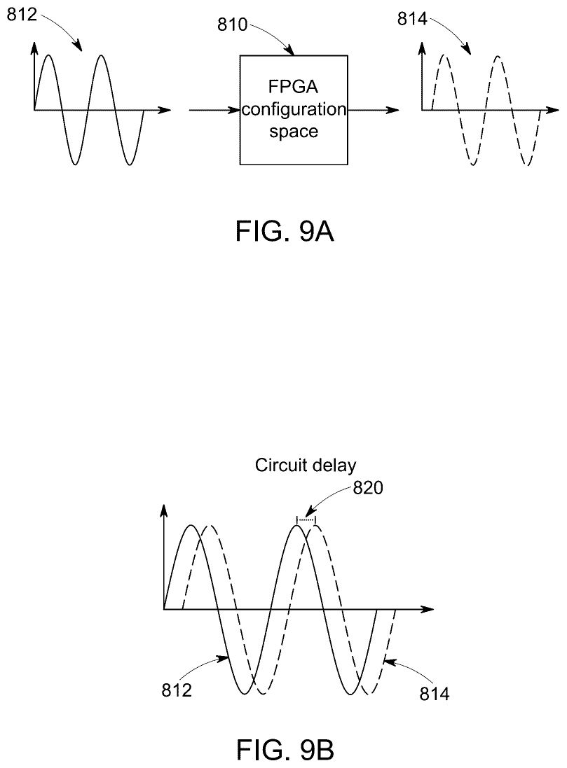

To further evaluate the impact of entropy annealing on semiconductor systems, additional tests were conducted using a simplified configuration space on an FPGA. Rather than constructing and testing fully functional PUFs comprising numerous ring oscillators and additional circuitry, a more straightforward approach involving delay testing was used. In this regard, FIG. 9A conceptually illustrates a simplified FPGA configuration space or circuit 810. While circuit 810 was being entropy annealed, rather than driving the global signals with the oscillating feedback signal of a ring oscillator-based PUF as was previously described, a static input signal 812 was used to drive the global signals, allowing for an analysis of delay within circuit 810 as it is being annealed.

By comparing static input signal 812 with the output signal 814, the delay introduced by circuit 810 can be measured. Specifically, with reference to FIG. 9B, the phase delay 820 between input signal 812 and output signal 814 was measured using an oscilloscope, with measurements taken at a specific threshold voltage. Phase delay 820 reflects how much output signal 814 lags behind input signal 812 due to the propagation delay within circuit 810 during annealing. Because a ring oscillator's frequency depends on the delay of the circuit on which it is implemented, phase delay 820 is a useful and reliable metric for understanding the behavior of circuit 810 as it iterates through the entropy annealing process, and for understanding the effect that unconstrained design techniques can have on circuit unknowns.

The relationship between the delay (T) and the frequency (f) of a ring oscillator can be expressed by using the formula:

$$f = 1 / ( 2 * N * T )$$

Where N represents the number of inversions in the oscillator and Tis the delay. As the delay T increases or decreases through the annealing process, the corresponding frequency shifts accordingly, making the delay T a useful and reliable basis for estimating the potential frequency range of the system.

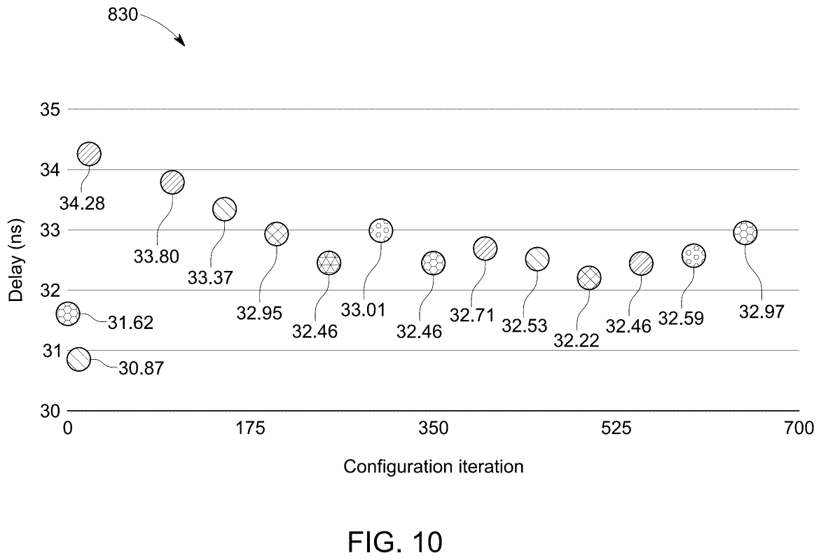

FIG. 10 is a scatter plot 830 showing how the delay varies across multiple annealing iterations. The x-axis of plot 830 represents the number of changes in the configuration space as the FPGA iterates through the anneal, and the y-axis shows the corresponding delay in nanoseconds (ns). The unpredictability introduced by the annealing process is shown in plot 830 by the fluctuating delays as the configuration evolves. This variability in delay leads to an inferred frequency range of approximately 3.2 MHz, with the longest delay corresponding to the lowest frequency and the shortest delay corresponding to the highest frequency. These results confirm that the annealing process introduces significant and unpredictable variability into the configuration space, enhancing the complexity of the resulting circuit while maintaining its key functional characteristics.

The entropy annealing process described herein, which employes ring oscillator-based PUFs at its core, retains the fundamental advantages of this architecture, including the ability to generate a vast number of unique challenge-response pairs (CRPs) while ensuring that the PUF is tied to the inherent manufacturing variability of the device without the need for external processing. These intrinsic and strong PUF features are essential to the system's security and resilience against potential exploits. As the system's entropy increases through the annealing process, the complexity of the PUF is enhanced, further strengthening its intrinsic properties. This evolution has the potential to significantly boost the security of the PUF, making it more resistant to attacks and cloning. Moreover, ring-based oscillators offer flexibility in their design: they can function as explicit PUFs that generate a single response, typically used in lower security applications, or as implicit PUFs, which are more secure and respond dynamically to varying inputs.

In some examples, as an alternative to the physical entropy annealing process described above, a simulated entropy annealing process provides a simplified yet efficient design path for generating high entropy circuits. The simulated entropy annealing process performs entropy-increasing operations in software using a hardware description language (HDL) rather than directly modifying an FPGA bitstream. HDL is a specialized computer language used to describe and design electronic circuits such as digital logic circuits like those implemented in FPGAs and application-specific integrated circuits (ASICs). Unlike a programming language such as Python or C, which defines software instructions executed sequentially by a CPU, an HDL defines hardware structures that operate concurrently (i.e., in parallel) in the same manner as the electronic components they represent. Verilog, for example, is a commonly used HDL for FPGA and ASIC design.

The simulated entropy annealing process may occur entirely in simulation, where each step of the annealing sequence is represented as HDL code, or it can be combined with limited on-device evaluation. Unlike the physical process, in which each modification is programmed and evaluated directly on FPGA hardware, the simulated entropy annealing process produces a configuration module in HDL that can be added to a design file and programmed only once. This represents a simpler but less optimized application of entropy annealing that is easier for developers to adopt using traditional FPGA design flows.

This approach avoids non-functional configurations that may occur when manipulating an FPGA bitstream directly. The HDL code is processed through electronic design automation (EDA) tools, which automatically synthesize, verify, and implement the design without the need for iterative testing or rollback of non-functional configurations. EDA tools are specialized software suites-such as Xilinx Vivado, Intel Quartus Prime, and Mentor Graphics Questa-that convert HDL source files into gate-level netlists, optimize logic for timing and area, and map those logical elements onto the physical resources of a target FPGA or ASIC. These tools perform several automated stages of analysis, including logic synthesis, constraint validation, placement and routing, and functional simulation, ensuring that the HDL description represents a circuit that can be successfully realized in hardware. By processing the HDL through EDA tools, the design is checked for syntax errors, invalid timing loops, unconnected signals, resource conflicts, etc. before it ever reaches the hardware. This ensures that only valid, synthesizable logic is used to generate the configuration bitstream, eliminating the need for a runtime fitness function or other trial-and-error reprogramming or rollback steps that are required in the physical entropy annealing process.

However, this simplification also reduces the degree of optimization achievable for fully unclonable behavior, which is why the physical entropy-annealing process is advantageous when maximum entropy and unpredictability are desired. Simplified entropy annealing, by contrast, focuses on working with unclonable variables that are well understood and compatible with standard design tools, such as path delays, and increases the influence of these unclonable variables on the circuit's timing characteristics while reducing noise.

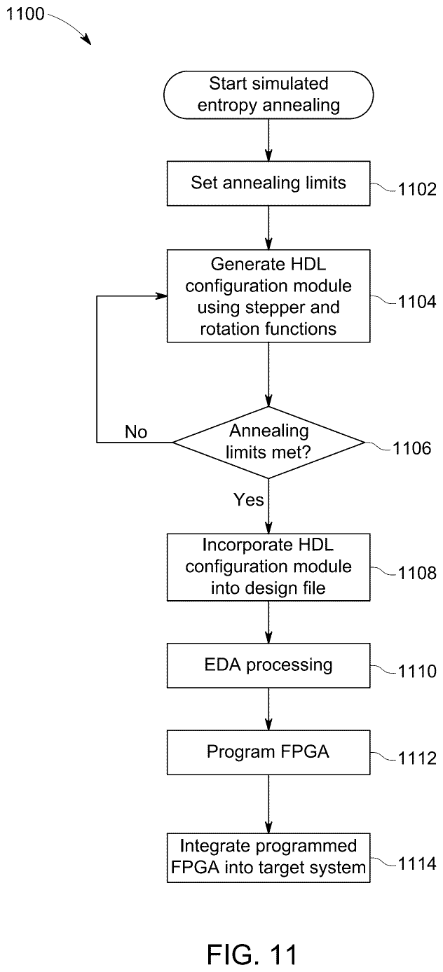

FIG. 11 is a flowchart illustrating an example of a simulated entropy annealing process 1100 in accordance with aspects of this disclosure. Simulated entropy annealing process 100 is initiated in a simulated environment rather than on physical hardware. In this context, a simulated environment refers to any FPGA design or verification platform that emulates hardware behavior before programming a device. Examples include open source tools such as Yosys and nextpnr, as well as commercial environments such as Xilinx Vivado Simulator, Intel Quartus Prime Pro Edition, and Mentor QuestaSim. These and other tools allow HDL-based designs to be compiled, verified, and timing-simulated on a workstation, accurately modeling signal propagation, routing delays, and resource utilization before an FPGA is actually configured.

In step 1102, the annealing limits are set. The developer defines the logical and physical boundaries for the simulated anneal by designating I/O connections and specifying FPGA resource constraints. In the context of simulated entropy annealing, annealing limits refer to design space boundaries established in software such as I/O designations, resource allocations, and logical partitions that constrain how far the simulated annealing process can evolve within the HDL design. Defining I/O designations involves identifying the logical inputs and outputs that form the boundaries of the entropy-annealed circuit. For example, IN_A, IN_B, and OUT_C may be defined as module interface signals and mapped to specific pins or virtual I/O ports in a constraint file (e.g., .xdc for Xilinx or .qsf for Intel). Setting resource limits determines how many CLBs, LUTs, or routing resources may be consumed during the anneal to ensure control of timing and power budgets. For example, the process may be limited to 2000 LUTs or 25 percent of the device fabric.

In step 1104, a configuration module is generated in HDL using simplified stepper and rotation functions that operate sequentially and deterministically. The simplified stepper function introduces small, incremental modifications to signal routing or logical relationships in the HDL-such as reordering inputs within Boolean expressions or altering LUT interconnections-rather than applying random bitstream changes. The simplified rotation function cycles systematically through available LUT inputs and outputs to ensure comprehensive coverage. This differs from the physical annealing process where changes occur randomly at the bitstream level and must be evaluated by a fitness function. In this manner, simulated entropy annealing produces a valid HDL structure that models the complexity of a physically annealed system but without the risk of generating unstable logic.

Step 1106 determines whether the annealing limits defined in step 1102 have been reached. If additional resources remain available (1106—NO), the process returns to step 1104 to continue generating the HDL configuration to increase entropy and complexity. If the annealing limits defined in step 1102 have been reached (1106—YES), the process proceeds to step 1108. The check of step 1106 corresponds, in real world development tools, to monitoring utilization summaries during simulation or synthesis (e.g., reviewing a utilization report in Vivado or a fit summary in Quartus).

Once the annealing limits have been reached, the finalized HDL module is incorporated into a text design file that may include additional system level logic (step 1108). In practical FPGA workflows, this entails adding the generated file (such as a .v (Verilog) or .vhd (VHDL) file, for example) to the project hierarchy and declaring the module within a top level entity. For example, the developer may connect the simulated entropy annealing module to a random number generator or encryption controller so that its entropy-based delays enhance the unpredictability of key generation.

The design file, including the entropy annealed module, is processed by EDA tools in step 1110 for synthesis, placement, and routing. During step 1110, the HDL logic is compiled into gate-level primitives, mapped to available FPGA resources, and arranged spatially within the device fabric. The EDA software performs design rule checks, constraint validation, and timing optimization to ensure that the design meets required performance and stability metrics. Step 1110 corresponds to invoking build commands such as launch synthesis; launch_implementation in Vivado or compile_design in Quartus, producing a verified configuration file (e.g., .bit or .sof). The output of EDA processing step 1110 is a bitstream output file.

In step 1112, the FPGA is programmed and validated using the bitstream output file from EDA processing step 1110. Programming the FPGA may involve transferring the configuration file to the device (such as by JTAG, USB-Blaster, or SPI interface), after which the HDL-encoded high-entropy circuit is instantiated in hardware. Functional verification may be performed using on-chip analyzers or test benches to confirm that the circuit exhibits the expected timing variability or entropy characteristics. Finally, in step 1114, the programmed FPGA is deployed or integrated into its target system. In real world use, this may involve embedding the programmed FPGA within a secure device, sensor interface, or authentication unit where the circuit generated by simulated entropy annealing provides intrinsic entropy, timing diversity, or other unclonable characteristics that enhance system security and uniqueness.

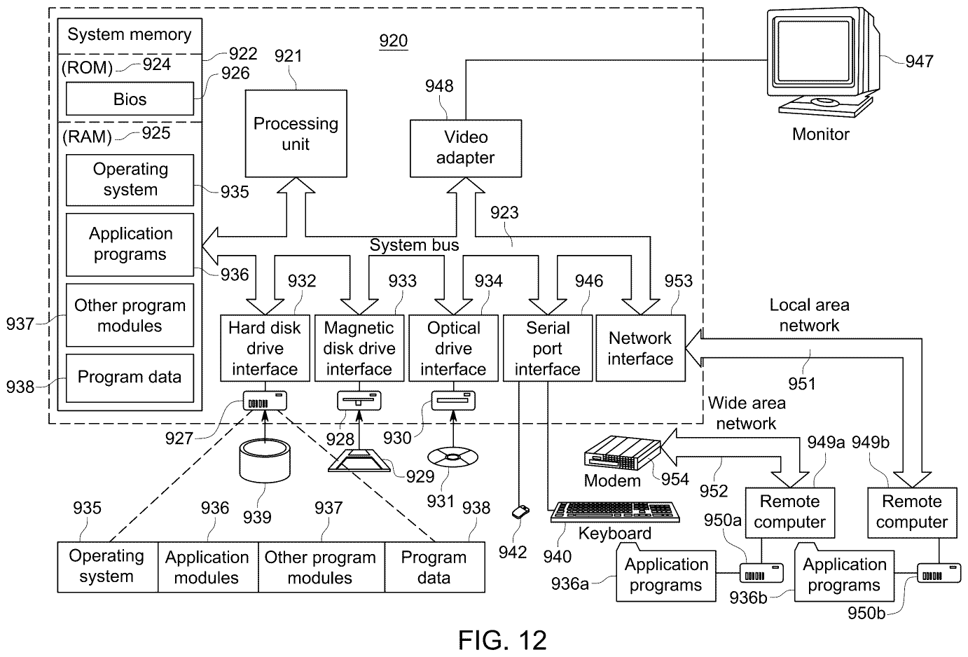

FIG. 12 is a block diagram of an exemplary computing environment that may implement some or all of the entropy annealing system and process for designing physical unclonable functions of this disclosure. The exemplary computing environment includes a general purpose computing device in the form of a conventional computer 920, including processing unit 921, system memory 922, and system bus 923 that couples various system components including system memory 922 to processing unit 921. It should be noted that as mobile phones become more sophisticated, they may incorporate many or all of the components of computer 920. Accordingly, with minor adjustments, mostly with respect to input/output devices, the description of computer 920 applies as well to mobile phones. System bus 923 may be any of several types of bus structures including a memory bus or memory controller, a peripheral bus, and a local bus using any of a variety of bus architectures. System memory 922 includes read only memory (ROM) 924 and random access memory (RAM) 925. A basic input/output system (BIOS) 926, containing the basic routines that help transfer information between elements within computer 920, such as during start-up, may be stored in ROM 924.

Computer 920 may also include magnetic hard disk drive 927 for reading from and writing to magnetic hard disk 939, magnetic disk drive 928 for reading from or writing to a removable magnetic disk 929, and optical disc drive 930 for reading from or writing to removable optical disk 931 such as a CD ROM or other optical media. Magnetic hard disk drive 927, magnetic disk drive 928, and optical disk drive 930 are connected to system bus 923 by hard disk drive interface 932, magnetic disk drive interface 933, and optical drive interface 934, respectively. The drives and their associated computer-readable media provide nonvolatile storage of computer-executable instructions, data structures, program modules, and other data for the computer 920. Although the exemplary environment described herein employs magnetic hard disk 939, removable magnetic disk 929, and removable optical disk 931, other types of computer readable media for storing data can be used, including magnetic cassettes, flash memory cards, digital versatile discs, Bernoulli cartridges, RAMs, ROMs, and the like.

Program code means comprising one or more program modules may be stored on hard disk 939, magnetic disk 929, optical disk 931, ROM 924, or RAM 925, including operating system 935, one or more application programs 936, other program modules 937, and program data 938. A user may enter commands and information into computer 920 through keyboard 940, pointing device 942, or other input devices (not shown), such as a microphone, joystick, game pad, satellite dish, scanner, motion detectors, or the like. These and other input devices are often connected to processing unit 921 through serial port interface 946 coupled to system bus 923. Alternatively, the input devices may be connected by other interfaces, such as a parallel port, a game port or a universal serial bus (USB). Monitor 947 or another display device is also connected to system bus 923 via an interface, such as video adapter 948. In addition to a monitor, personal computers typically include other peripheral output devices (not shown), such as speakers and printers.

Computer 920 may operate in a networked environment using logical connections to one or more remote computers, such as remote computers 949a and 949b. Remote computers 949a and 949b may each be another personal computer, a server, a router, a network PC, a peer device, or other common network node, and typically include many or all of the elements described above relative to computer 920, although only memory storage devices 950a and 950b and their associated application programs 936a and 936b are illustrated in FIG. 12. The logical connections depicted in FIG. 12 include local area network (LAN) 951 and wide area network (WAN) 952, which are presented by way of example and not limitation. Such networking environments are commonplace in office-wide or enterprise-wide computer networks, intranets, and the Internet.

When used in a LAN networking environment, computer 920 can be connected to local network 951 through network interface or adapter 953. When used in a WAN networking environment, computer 920 may include modem 954, a wireless link, or other means for establishing communications over wide area network 952, such as the Internet. Modem 954, which may be internal or external, is connected to system bus 923 via serial port interface 946. In a networked environment, program modules depicted relative to computer 920, or portions thereof, may be stored in a remote memory storage device. The network connections shown are exemplary and other means of establishing communications over wide area network 952 may be used.

While certain embodiments are described herein, these embodiments are presented by way of example only, and do not limit the scope of this disclosure. Various omissions, substitutions and changes may be made without departing from the spirit and scope of this disclosure. The methods and processes described herein are not limited to any particular sequence and may be used independently or combined in various ways. Some method or process steps may be omitted and other steps added in some implementations. Nothing in this description implies that any particular feature, component, characteristic, or step is necessary or indispensable. Many variations, modifications, additions, and improvements are possible and fall within the scope of this disclosure as defined by the following claims.

1. A method for configuring a physical unclonable function (PUF) on a field programmable gate array (FPGA) comprising:
generating a bitstream with an initial configuration to configure the PUF in the FPGA in a low entropy state;
progressively modifying the bitstream by introducing incremental and random modifications that increase entropy of the PUF;
evaluating modifications relative to predefined fitness criteria, wherein modifications that meet or exceed the predefined fitness criteria are retained in the bitstream, and modifications that fall below the predefined fitness criteria are not retained in the bitstream; and
iteratively repeating the process of modification and evaluation until an annealing limit is met to provide a high entropy PUF circuit.

2. The method of claim 1, wherein the PUF comprises a ring oscillator implemented in the FPGA.

3. The method of claim 1, wherein configuring the PUF in the low-entropy state comprises configuring inputs of look-up tables (LUTs) in a selected region of the FPGA to be driven by globally distributed signals that are fed back from an output of the PUF.

4. The method of claim 1, wherein progressively modifying the bitstream comprises changing at least one of: (i) programming of a look-up table (LUT) to alter a logic function; and (ii) routing of spans between LUTs to alter interconnections.

5. The method of claim 1, wherein introducing incremental and random modifications comprises applying a stepper function that makes incremental adjustments to the bitstream.

6. The method of claim 1, wherein progressively modifying the bitstream comprises applying a rotation function that ensures that each input of each look-up table (LUT) in a selected FPGA configuration space is selected for potential modification.

7. The method of claim 6, wherein the rotation function is scheduled according to a decay curve.

8. The method of claim 1, wherein the predefined fitness criteria require maintenance of ring-oscillator macrostate functionality.

9. The method of claim 8, wherein the ring-oscillator macrostate functionality is determined by edge detection of an oscillating signal.

10. The method of claim 1, wherein evaluating modifications relative to the predefined fitness criteria comprises comparing a performance score of a current configuration to a weighted moving average of prior performance scores and reversing a last modification when the current performance score is below the weighted moving average.

11. The method of claim 1, further comprising tracking a globally driven look-up table (LUT) inputs (GLDI) metric and adjusting a rate of modification based at least in part on the GLDI metric.

12. The method of claim 1, wherein the annealing limit comprises at least one of: (i) a bound on a set of tiles of the FPGA available for modification, and (ii) a bound on spans available for routing changes.

13. The method of claim 1, wherein progressively modifying the bitstream further comprises monitoring entropy growth across successive iterations and applying an entropy-rate decay function to control the rate of change.

14. The method of claim 1, wherein the bitstream modifications are performed during operation of the FPGA so that functional verification of the PUF occurs dynamically.

15. The method of claim 1, further comprising recording configuration metrics including delay, frequency, and power for each iteration to evaluate fitness trends.

16. The method of claim 1, wherein the stepper and rotation functions are executed by an external computer communicating with the FPGA over a programming interface.

17. A method for configuring a high entropy circuit on a field programmable gate array (FPGA) by simulated entropy annealing, comprising:
generating, in a simulated environment, a configuration module in a hardware-description language (HDL);
modifying the HDL configuration module by introducing incremental modifications that increase entropy of the circuit while maintaining logical functionality;
iteratively repeating modifying the HDL configuration module until annealing limits are met to produce a high entropy HDL configuration module;
processing the high entropy HDL configuration module using an electronic design automation (EDA) tool to generate a device-specific configuration file; and
programming the FPGA with the device-specific configuration file to implement the high entropy circuit.

18. The method of claim 17, wherein the HDL configuration module is generated using stepper and rotation functions that sequentially build interconnections among look-up tables (LUTs).

19. The method of claim 17, further comprising setting the annealing limits be designating input and output connections and specifying resource constraints for the FPGA.

20. The method of claim 17, wherein processing the high entropy HDL configuration module comprises performing synthesis, placement, and routing using the EDA tool.
